(19) United States
(12) Patent Application Publication
(10) Pub. No.: US 2009/0087243 A1
(43) Pub. Date: Apr. 2, 2009

(54) WRITING APPARATUS, IMAGE FORMING APPARATUS, MANAGEMENT APPARATUS, LABEL CREATION SYSTEM, AND COMPUTER READABLE MEDIUM STORING PROGRAM THEREOF

(75) Inventor: Kenichi NIIYAMA, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/053,412

(22) Filed: Mar. 21, 2008

(30) Foreign Application Priority Data
Sep. 28, 2007 (JP) 2007-254764

(51) Int. Cl. B41J 11/44

(52) U.S. Cl. 400/76

(57) ABSTRACT

A writing apparatus includes a reading unit that reads, from a paper sheet having plural labels embedded with wireless IC elements, each including a wireless communication unit and a storage unit storing data that is transmitted and received via the wireless communication unit, identification information to identify a set of pieces of information to be written respectively into the plural wireless IC elements; an acquisition unit that acquires a set of pieces of information to be written respectively into the plural wireless IC elements, based on the identification information read by the reading unit; and plural writing components that are provided corresponding to the plural wireless IC elements and write plural pieces of information to be written acquired by the acquisition unit into the plural wireless IC elements, respectively.

### CROSS-REFERENCE TO RELATED APPLICATIONS

This application is based on and claims priority under 35 USC 119 from Japanese Patent Application No. 2007-254764 filed Sep. 28, 2007.

### BACKGROUND

### TECHNICAL FIELD

The present invention relates to a writing apparatus, an image forming apparatus, a management apparatus, a label creation system, and a computer readable medium storing a program thereof.

### SUMMARY

An aspect of the invention resides in a writing apparatus including:

a reading unit that, reads from a paper sheet having plural labels embedded with wireless IC elements, each having a wireless communication unit and a storage unit storing data that is transmitted and received via the wireless communication unit, identification information to identify a set of pieces of information to be written respectively into the plural wireless IC elements;

an acquisition unit that acquires a set of pieces of information to be written respectively into the plural wireless IC elements, based on the identification information read by the reading unit; and

plural writing components that are provided corresponding to the plural wireless IC elements and write plural pieces of information to be written acquired by the acquisition unit into the plural wireless IC elements, respectively.

### BRIEF DESCRIPTION OF THE DRAWINGS

An exemplary embodiment of the present invention will be described in detail based on the following figures, wherein:

FIG. 1 is a system diagram depicting a framework of a label creation system according to one exemplary embodiment of the invention;

FIG. 2 illustrates an example of a label paper sheet 60 which is used in the label creation system in accordance with the one exemplary embodiment of the invention;

FIG. 3 depicts the structure of a label 51, one of the labels in a label paper sheet 60.

FIG. 4 is a block diagram showing a hardware structure of a management apparatus 20 in the label creation system in accordance with the one exemplary embodiment of the invention;

FIG. 5 is a block diagram showing an arrangement of functions of the management apparatus 20 in the label creation system in accordance with the one exemplary embodiment of the invention;

FIG. 6 illustrates an example of a screen display appearing when inputting image data and information to be written by an input part 21;

FIG. 7 illustrates an example of information which is stored in an information storage 22 of the management apparatus 20;

FIG. 8 illustrates an example of information to be printed which is transmitted by a transmitter 24 of information to be printed to an image forming apparatus 10.

FIG. 9 is a flowchart illustrating operation from generating information to be written and image data until storing them by the management apparatus 20;

FIG. 10 is a block diagram showing a hardware structure of the image forming apparatus 10 in the label creation system in accordance with the one exemplary embodiment of the invention;

FIG. 11 is a block diagram showing an arrangement of functions of the image forming apparatus 10 in the label creation system in accordance with the one exemplary embodiment of the invention;

FIG. 12 illustrates an example of a label paper sheet 60 printed by the image forming apparatus 10;

FIG. 13 is a block diagram showing a hardware structure of a wireless IC tag writing apparatus 30 in the label creation system in accordance with the one exemplary embodiment of the invention;

FIG. 14 is a block diagram showing an arrangement of functions of the wireless IC tag writing apparatus 30 in the label creation system in accordance with the one exemplary embodiment of the invention;

FIG. 15 illustrates an outline structure of the wireless IC tag writing apparatus 30 in the label creation system in accordance with the one exemplary embodiment of the invention;

FIG. 16 illustrates a structure of a reader/writer unit 33; and

FIG. 17 is a flowchart illustrating the operation of the wireless IC tag writing apparatus 30.

### DETAILED DESCRIPTION

An exemplary embodiment of the present invention will then be described in detail with reference to the drawings.

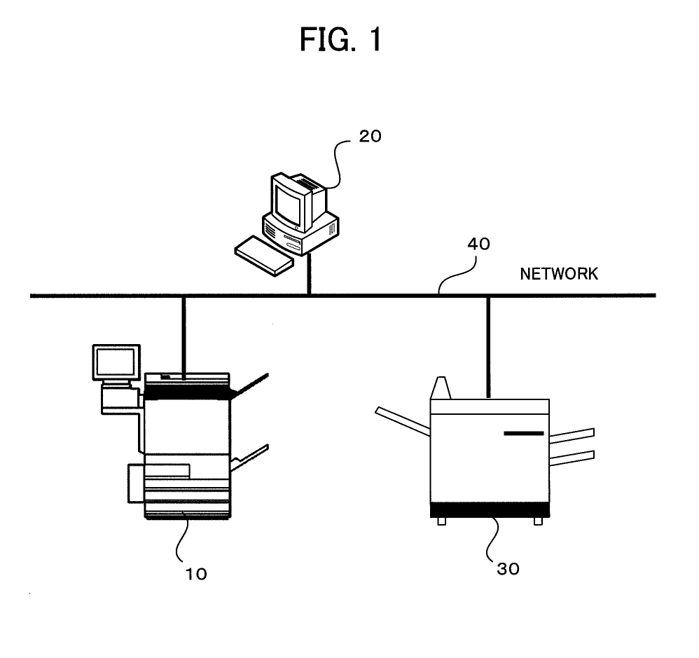

FIG. 1 is a system diagram depicting a framework of a label creation system according to one exemplary embodiment of the present invention.

The label creation system of the present exemplary embodiment is a system for printing a certain image onto a label provided with a wireless IC tag and writing data associated with the printed image into the wireless IC tag in the label. In the present exemplary embodiment, the label creation system for creating labels to be attached to each of books stocked in a library is taken as an example for explanation. On each label, information for identifying each book is printed as a bar code and the same information is stored into the wireless IC tag embedded in the label.

The wireless IC tag may be any other wireless IC element in which information such as its own identification code is recorded and which is able to transmit and receive information to/from a management system over radio waves.

The wireless IC element may be provided in various forms such as label, card, coin, and stick, from which a form for application is selected. Its communication range also varies from several millimeters to several meters and a range is selected for application.

As shown in FIG. 1, the label creation system of the present exemplary embodiment is composed of an image forming apparatus 10, a management apparatus 20, and a wireless IC tag writing apparatus 30 interconnected via a network 40.

The management apparatus 20 manages image data to be printed on a label and data to be written into a wireless IC tag within a label.

The image forming apparatus 10 accepts data to be printed, transmitted from the management apparatus 20, and outputs an image on printing paper from the data to be printed. An example of the image forming apparatus 10 may be equipment like a complex machine having facsimile, printing, and scanner functions.

The wireless IC tag writing apparatus 30 performs writing of data received from the management apparatus 20 into the wireless IC tag provided in a label.

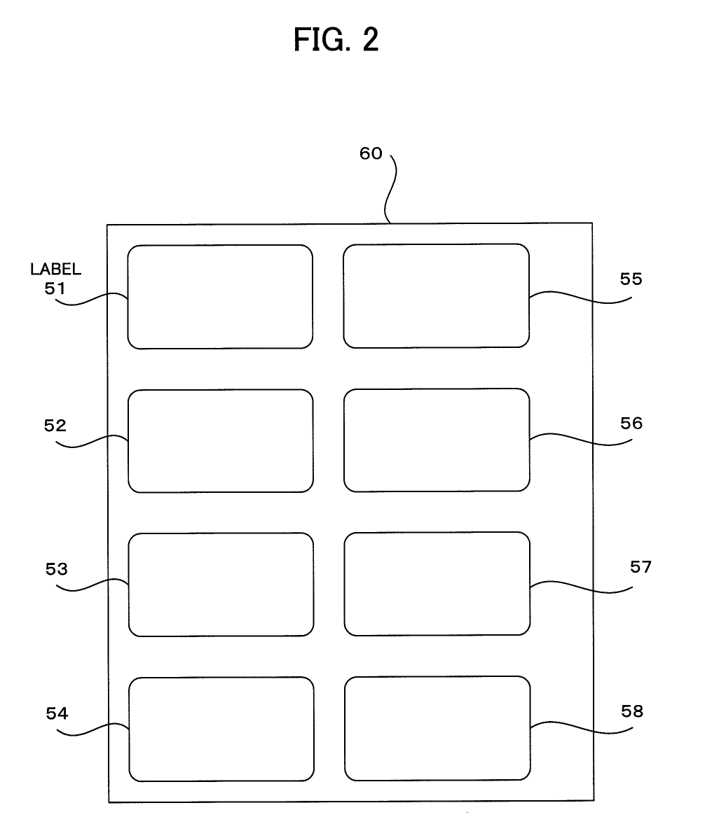

An example of a label paper sheet 60 which is used in such label creation system of the present exemplary embodiment is depicted in FIG. 2.

As shown in FIG. 2, the label paper sheet 60 which is used in the label creation system of the present exemplary embodiment is made up of eight labels 51 to 58, in each of which one wireless IC tag is provided respectively.

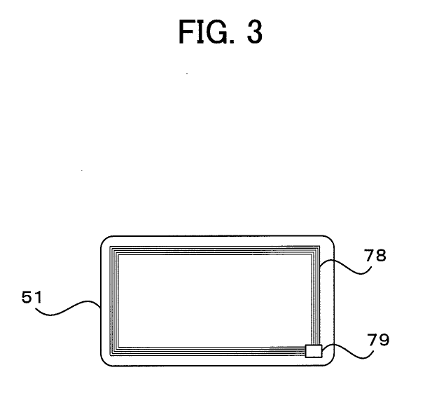

Then, a structure of each of the labels 51 to 58 is described. Because the labels 51 to 58 have the same structure, the structure of a label 51 is described here with reference to FIG. 3.

In the label 51, a wireless IC tag composed of an IC chip 79 and an antenna 78 is provided, as shown in FIG. 3. The IC chip 79 is provided with a wireless communication unit for wireless communication with the wireless IC tag writing apparatus 30 and a memory which is a storage unit storing data which is transmitted and received by the wireless communication unit. The wireless communication unit performs wireless communication with the wireless IC tag writing apparatus 30 via the antenna 78. Through this wireless communication, information is read from and information is written to the memory in the IC chip 79.

As the material of the label 51, any other material such as plastics may be used, provided it is good for being attached to an article or a container to indicate a trademark, an article name, a classification symbol, a destination, etc.

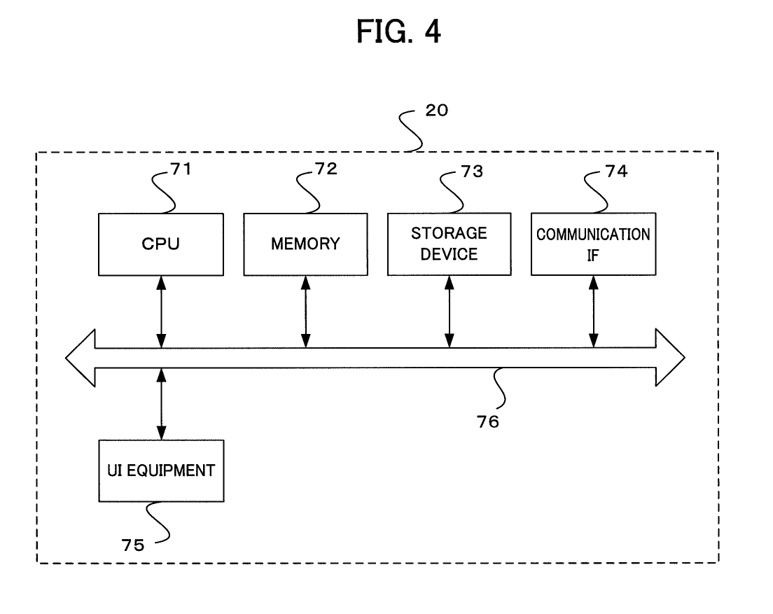

Then, a hardware structure of the management apparatus 20 in the label creation system of the present exemplary embodiment is shown in FIG. 4.

As shown in FIG. 4, the management apparatus 20 includes a CPU 71, a memory 72, a storage device 73 such as a hard disk drive (HDD), a communication interface (IF) 74 for transmitting and receiving data from/to the image forming apparatus 10, the wireless IC tag writing apparatus 30, and others via the network 40, and user interface (UI) equipment 75 including a touch panel or a liquid crystal display and a keyboard. These components are interconnected via a control bus 76.

The CPU 71 executes prearranged processing based on an image processing program stored in the memory 72 or storage device 73 and controls the operation of the management apparatus 20.

In the present exemplary embodiment, the CPU 71 reads and executes a control program stored in the memory 72 or storage device 73 in the above description. Alternatively, the program can be stored in a storage medium such as a CD-ROM and provided to the CPU 71.

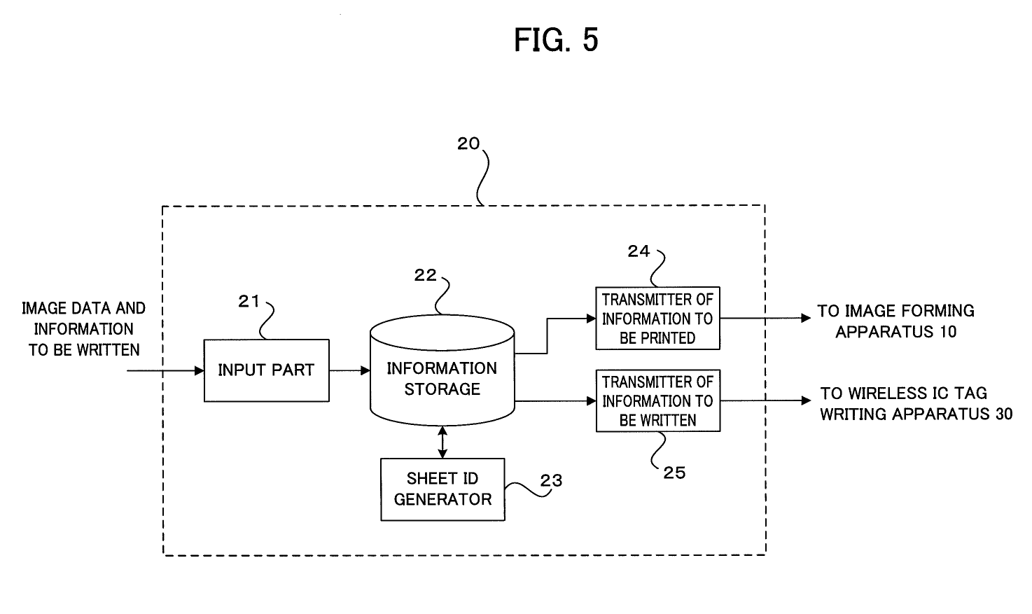

FIG. 5 is a block diagram showing an arrangement of functions of the management apparatus 20, which are realized by the execution of the above control program.

As shown in FIG. 5, the management apparatus 20 is provided with an input part 21, an information storage 22, a sheet ID generator 23, a transmitter 24 of information to be printed, and a transmitter 25 of information to be written.

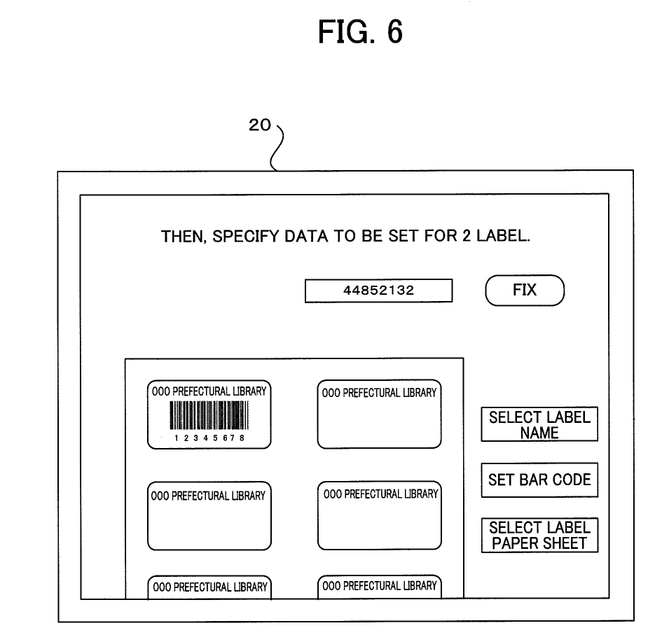

The input part 21 inputs image data to be printed on labels and information to be written into the wireless IC tags provided in the labels. An example of a screen display appearing when inputting image data and information to be written by the input part 21 is shown in FIG. 6.

In the display example shown in FIG. 6, an input method is presented in which a paper sheet of A4 size in which eight labels are arranged is selected and data to be stored per label is specified. Setting of image data to be printed on each label and a common label name to be assigned to plural labels can be selected.

Among a whole set of plural pieces of image data and corresponding information to be written, entered by the input part 21, the sheet ID generator 23 generates a sheet ID (identification information) to identify a set of eight pieces of image data and corresponding information to be written for the number of labels contained in one label paper sheet.

The information storage 22 stores a set of plural pieces of information to be written into plural wireless IC tags provided in a label paper sheet and plural pieces of image data to be printed on each label in the label paper sheet, associated with a sheet ID generated by the sheet ID generator 23.

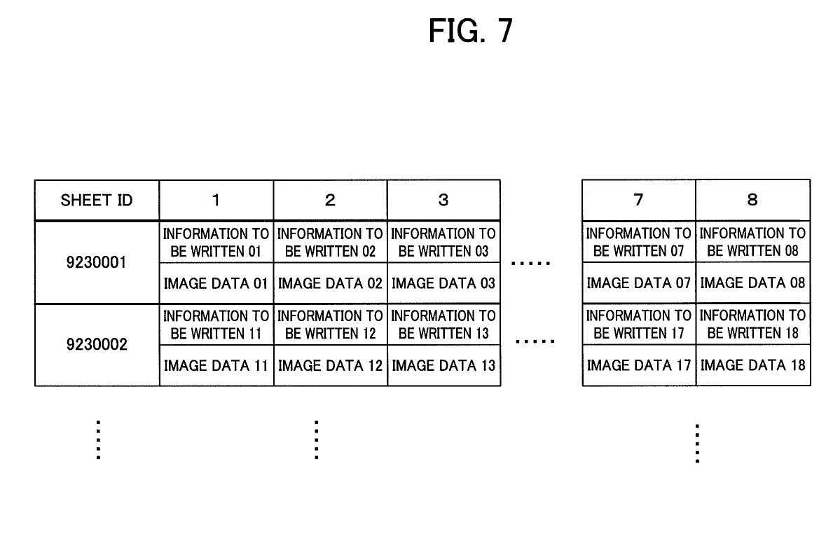

An example information that is stored in the information storage 22 is shown in FIG. 7. In the example shown in FIG. 7, for example, information “9230001” as a sheet ID is associated with a set of eight pieces of information to be written 01 to 08 and eight pieces of image data 01 to 08 for eight labels and stored with this set in the information storage 22.

The transmitter 24 of information to be printed transmits a set of eight pieces of image data per label paper sheet together with the sheet ID, stored in the information storage 22, to the image forming apparatus 10.

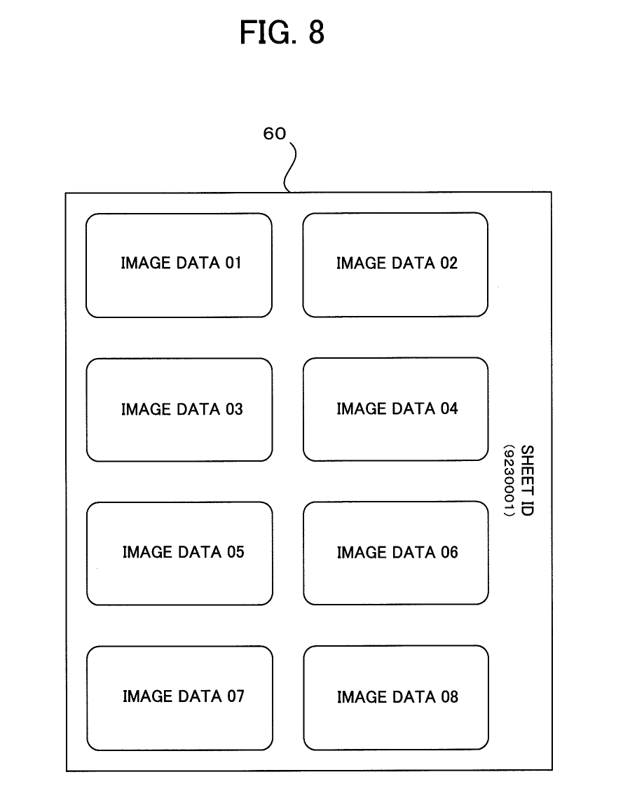

For example, if data as presented in FIG. 7 is stored in the information storage 22, the transmitter 24 of information to be printed transmits information to be printed which is illustrated in FIG. 8 to the image forming apparatus 10.

In particular, the transmitter 24 of information to be printed transmits to the image forming apparatus 10 information to be printed in which eight pieces of image data 01 to 08 will be printed in positions corresponding to eight labels 51 to 58 in a label paper sheet 60 and identification information, sheet ID “9230001” will be printed in a forward end margin of the sheet toward forward in the direction in which the label paper sheet 60 is transported.

When the transmitter 25 of information to be written receives information for a sheet ID from the wireless IC tag writing apparatus 30, it transmits a set of eight pieces of information to be written for eight labels associated with the received sheet ID to the wireless IC tag writing apparatus 30.

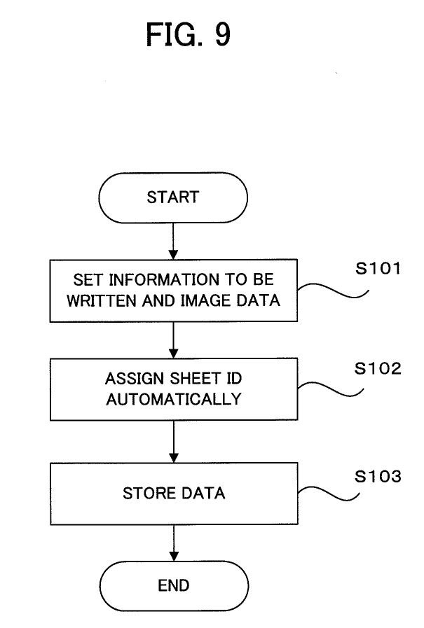

Then, an example of operation from generating information to be written and image data until storing them by the management apparatus 20 is illustrated in a flowchart of FIG. 9.

When image data to be printed on labels and information to be written into wireless IC tags are entered by the input part 21 (step S101), a sheet ID for every set of data for eight labels is set by the sheet ID generator 23 (step S102). The image data and the information to be written, entered by the input part 21, together with the sheet ID generated by the sheet ID generator 23, are stored into information storage 22 (step 103).

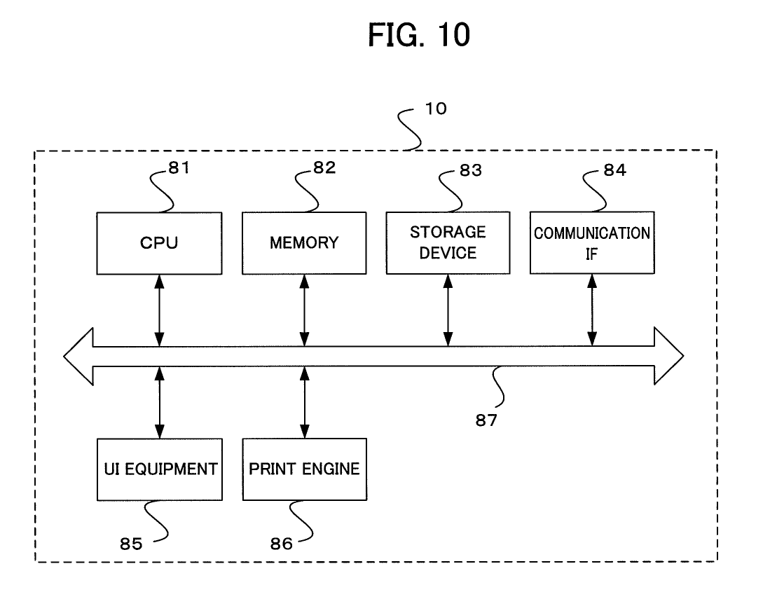

A hardware structure of the image forming apparatus 10 in the label creation system of the present exemplary embodiment is shown in FIG. 10.

As shown in FIG. 10, the image forming apparatus 10 includes a CPU 81, a memory 82, a storage device 83 such as a hard disk drive (HDD), a communication interface (IF) 84 for transmitting and receiving data from/to the management apparatus 20, the wireless IC tag writing apparatus 30, and others via the network 40, user interface (UI) equipment 85 including a touch panel or a liquid crystal display and a keyboard, and a print engine 86. These components are interconnected via a control bus 87.

The CPU 81 executes prearranged processing based on a control program stored in the memory 82 or storage device 83 and controls the operation of the image forming apparatus 10.

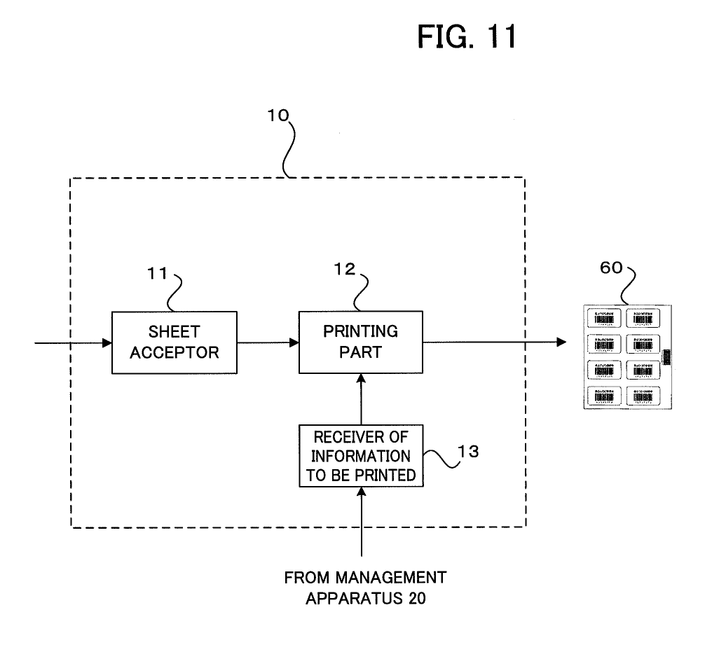

FIG. 11 is a block diagram showing an arrangement of functions of the image forming apparatus 10, which are realized by the execution of the above control program.

As shown in FIG. 11, the image forming apparatus 10 of the present exemplary embodiment includes a sheet acceptor 11, a printing part 12, and a receiver 13 of information to be printed.

The sheet acceptor 11 accepts a label paper sheet 60 provided with plural wireless IC tags. The receiver 13 of information to be printed receives image data and sheet ID information to be printed on a label paper sheet 60 from the management apparatus 20 via the network 40.

The printing part 12 prints out image data and sheet ID information received by the receiver 13 of information to be printed on a label paper sheet 60 accepted by the sheet acceptor 11.

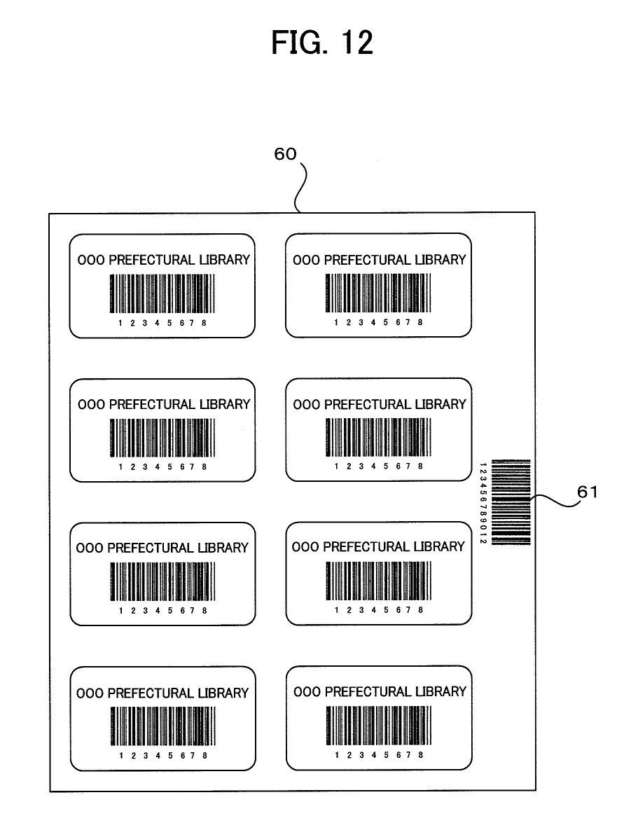

The image forming apparatus 10 configured as above prints information to be printed from the management apparatus 20 on a label paper sheet, thus producing a label paper sheet 60 which is illustrated in FIG. 12. On the label paper sheet 60, respectively set image data is printed on each label and the sheet ID information 61 is printed as a bar code in a longitudinal margin of the label paper sheet 60. The respectively set image data for each label is printed as the images of bar codes in which information to be written is represented.

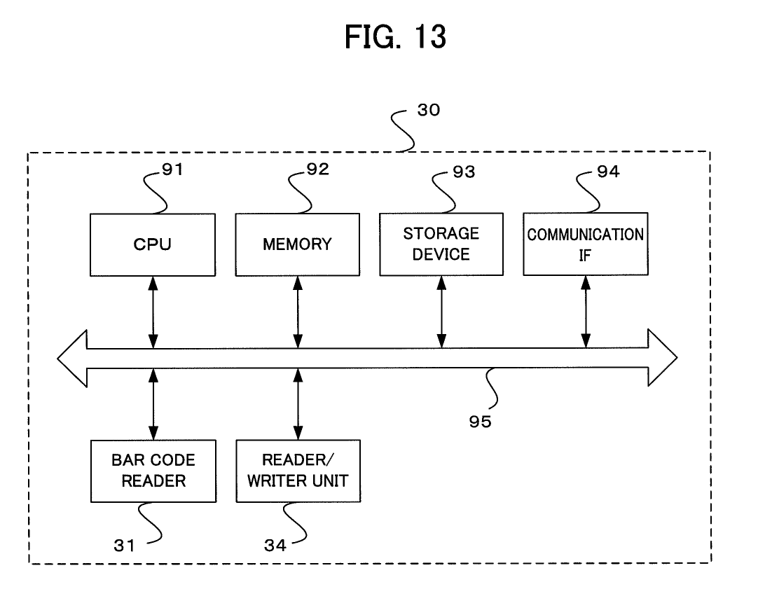

Then, a hardware structure of the wireless IC tag writing apparatus 30 in the label creation system of the present exemplary embodiment is shown in FIG. 13.

As shown in FIG. 13, the wireless IC tag writing apparatus 30 includes a CPU 91, a memory 92, a storage device 93 such as a hard disk drive (HDD), a communication interface (IF) 94 for transmitting and receiving data from/to the management apparatus 20 via the network 40, a bar code reader 31, and a reader/writer unit 34. These components are interconnected via a control bus 95.

The CPU 91 executes prearranged processing based on a control program stored in the memory 92 or storage device 93 and controls the operation of the wireless IC tag writing apparatus 30.

In the present exemplary embodiment, the CPU 91 reads and executes a control program stored in the memory 92 or storage device 93 in the above description. Alternatively, the program can be stored in a storage medium such as a CD-ROM and provided to the CPU 91.

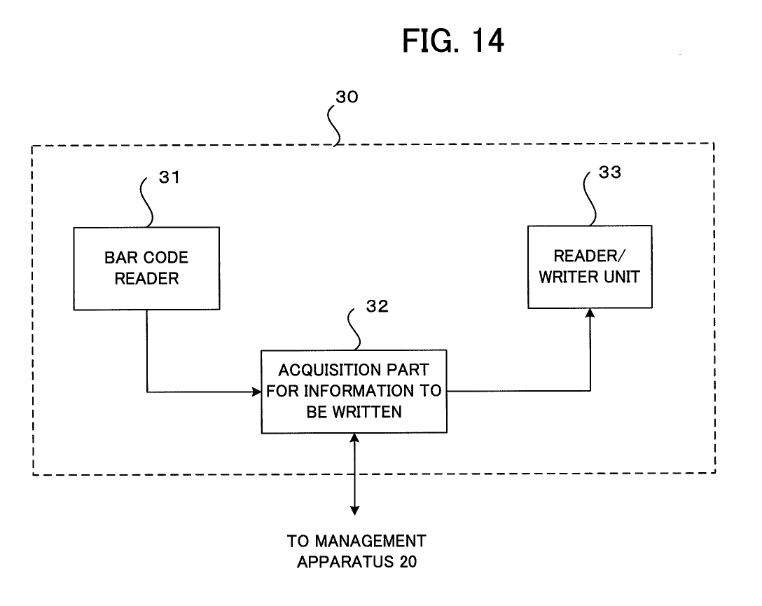

FIG. 14 is a block diagram showing an arrangement of functions of the wireless IC tag writing apparatus 30, which are realized by the execution of the above control program.

As shown in FIG. 14, the wireless IC tag writing apparatus 30 includes a bar code reader 31, an acquisition part 32 for information to be written, and a reader/writer unit 33.

The bar code reader 31 reads the sheet ID from a label paper sheet 60 with labels on which image data has been printed to identify information to be written into the respective wireless IC tags on the sheet.

Based on the sheet ID information read by the bar code reader 31, the acquisition part 32 for information to be written acquires plural pieces of information to be written into the plural wireless IC tags on the sheet from the management apparatus 20 via the network 40.

The reader/writer unit 33 is composed of eight readers/writers. The eight readers/writers write eight pieces of information to be written acquired by the acquisition part 32 for information to be written into the eight wireless IC tags on the label paper sheet 60, respectively.

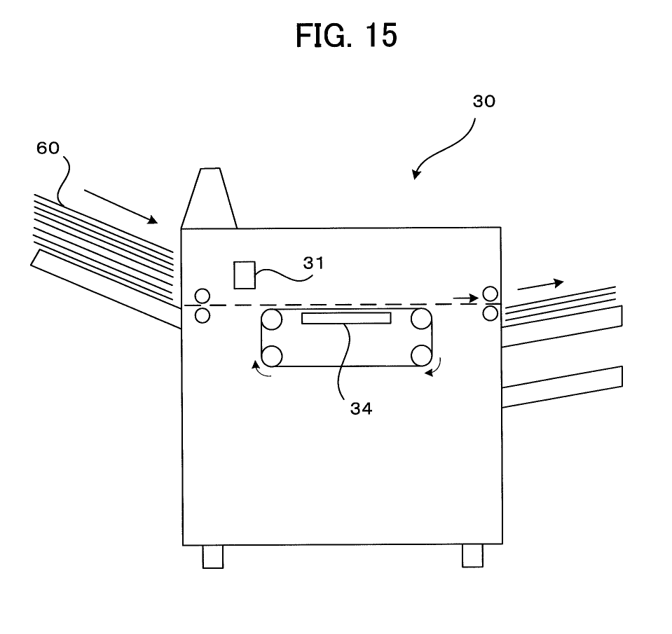

Then, an outline structure of the wireless IC tag writing apparatus 30 is shown in FIG. 15.

As shown in FIG. 15, the wireless IC tag writing apparatus 30 includes various transport units for transporting a label paper sheet 60 on which image data has been printed by the image forming apparatus 10 and is configured such that, during sheet transportation by the transport units, sheet ID information 61 printed as a bar code in a fixed position on the sheet is read by the bar code reader 31.

In the middle of the transport path, the reader/writer unit 33 is provided. The label paper sheet 60 being transported will stop once at a predetermined position over the reader/writer unit 33, when detected by a sensor not shown. It may be arranged to stop the label paper sheet 60 at a timing relative to the timing at which the sheet ID information 61 has been read by the bar code reader 31.

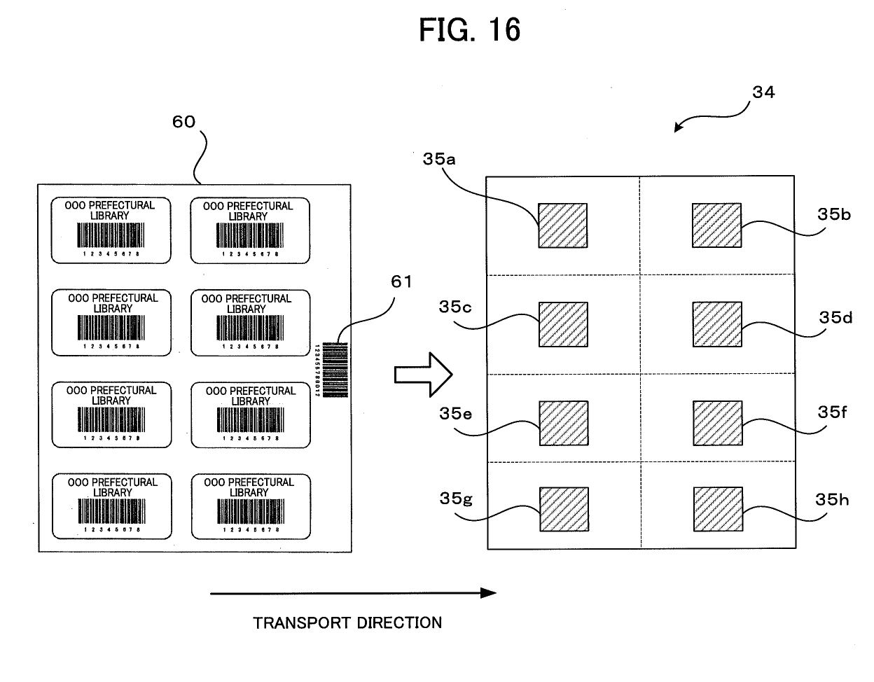

Then, a structure of the reader/writer unit 33 is shown in FIG. 16. The reader/writer unit 33 is composed of eight readers/writers 35a to 35h respectively provided in positions corresponding to the positions of eight wireless IC tags provided on a label paper sheet 60.

The eight readers/writers 35a to 35h write eight pieces of information to be written acquired by the acquisition part 32 for information to be written into the eight wireless IC tags on the label paper sheet 60, respectively.

Sheet ID information 61 is located in the forward end margin of the sheet toward the transport direction of a label paper sheet 60. Sheet ID is printed on the label paper sheet 60 such that bars (lines) constituting the bar code printed as the sheet ID information 61 are parallel to the transport direction. In some implementation, sheet ID information 61 may be located in an arbitrary position on a label paper sheet 60 and that position can be specified by the user. Also, this information may be printed such that bars (lines) constituting the bar code is perpendicular to the transport direction.

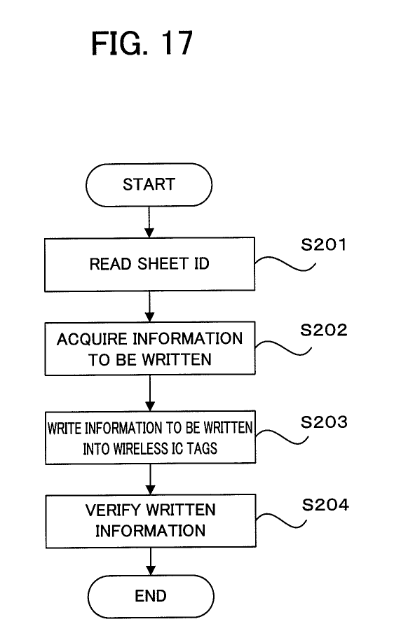

Then, the operation of the wireless IC tag writing apparatus 30 in the label creation system of the present exemplary embodiment is described with reference to a flowchart of FIG. 17.

When a label paper sheet 60 having image data printed thereon by the image forming apparatus 10 is accepted by the wireless IC tag writing apparatus 30, sheet ID information 61 printed in a fixed position on the label paper sheet 60 is first read by the bar code reader 31 (step S201).

Then, the acquisition part 32 for information to be written transmits the sheet ID read by the bar code reader 31 to the management apparatus 20 and receives a set of eight pieces of information to be written for eight labels associated with the sheet ID from the management apparatus 20 (step S202).

When the label paper sheet 60 being transported stops over the reader/writer unit 33, the eight readers/writers 35a to 35h of the reader/writer unit 33 simultaneously write the respective pieces of information to be written into eight wireless IC tags in the label paper sheet 60 (step S203).

Finally, the readers/writers 35a to 35h verify that the respective pieces of information to be written have been written properly by reading those pieces of information written into the eight wireless IC tags in the label paper sheet 60 and comparing them to the corresponding pieces of information that is supposed to have been written (step S204).

If a mismatch in information is found by comparison in the verifying step S204, the writing is performed again. If a successful writing result cannot be obtained even after the rewriting, it is judged that the involved wireless IC tag(s) has any fault such as a malfunction. Such an unsuccessful writing result is notified to the management apparatus 20. Therefore, it is possible for the management apparatus 20 to make label data that has failed to be written to the wireless IC tag(s) created again on another label paper sheet 60.

The label paper sheet 60 in which the specified pieces of information to be written have been written into eight wireless IC tags in this way is output from the wireless IC tag writing apparatus 20.

### MODIFICATION EXAMPLES

In the above-described exemplary embodiment, a bar code which is a one-dimensional code is used as a sheet ID which is identification information; however, the present invention is not so limited. The invention is applicable in the same way even when other identification information such as a Quick Response (QR) code which is a two-dimensional code is used as a sheet ID.

If the QR code is used, it is possible to include a set of information to be written for eight labels in an QR code, so that this set of information can directly be written into the wireless IC tags of the labels without query to the management apparatus 20.

In the above-described exemplary embodiment, one label paper sheet 60 contains eight labels 51 to 58. The invention is applicable in the same way, provided that one label sheet contains plural labels.

In the above-described exemplary embodiment, after printing image data on the labels, corresponding information is written into the wireless IC tags of the labels. Inversely, after writing information into the wireless IC tags of the labels, image data may be printed on the labels. In the latter case, the image forming apparatus 10 is provided with readers/writers for reading and writing information from/to wireless IC tags. By searching for image data corresponding to the information to be written that has been written into one of eight labels from the information storage 22 of the management apparatus 20, the image data to be printed on the label can be determined.

In the above-described exemplary embodiment, sheet ID information 61 is printed separately from bar code images printed on the labels. A bar code image printed on at least any of the plural labels may be used as sheet ID information 61 also. For example, in the information storage 22, sheet ID information 61 may be set identical to code information of a bar code image to be printed on a label in the forward left position on a label paper sheet 60 toward the transport direction, and the bar code reader 31 may be configured to read the bar code image printed on the label in the forward left position on a label paper sheet 60 toward the transport direction.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. A writing apparatus comprising:
a reading unit that reads, from a paper sheet having a plurality of labels embedded with wireless integrated circuit (IC) elements, each including a wireless communication unit and a storage unit storing data that is transmitted and received via the wireless communication unit, identification information to identify a set of pieces of information to be written respectively into the plurality of wireless IC elements;
an acquisition unit that acquires a set of pieces of information to be written respectively into the plurality of wireless IC elements, based on the identification information read by the reading unit; and
a plurality of writing components that are provided corresponding to the plurality of wireless IC elements and write a plurality of pieces of information to be written acquired by the acquisition unit into the plurality of wireless IC elements, respectively.

2. The writing apparatus according to claim 1, further comprising transport units that transport the paper sheet,
wherein the identification information is located in a forward end margin of the sheet toward forward in the paper sheet transport direction.

3. The writing apparatus according to claim 1, wherein the identification information is a bar code printed on the paper sheet.

4. The writing apparatus according to claim 2, wherein the identification information is a bar code printed on the paper sheet.

5. The writing apparatus according to claim 3, wherein the bar code is printed on the paper sheet such that lines constituting the bar code are parallel to the transport direction.

6. The writing apparatus according to claim 4, wherein the bar code is printed on the paper sheet such that lines constituting the bar code are parallel to the transport direction.

7. A management apparatus comprising:
a storage unit that stores information to be written into a plurality of labels present on a paper sheet and a plurality of pieces of image data to be printed respectively on the plurality of labels present on the paper sheet, associated with identification information;
a transmitting unit for information to be printed that transmits, to an image forming apparatus, a set of a plurality of pieces of image data for one paper sheet together with the paper's identification information stored in the storage unit; and
a transmitting unit for information to be written that transmits, upon receiving the identification information, a set of a plurality of pieces of information to be written associated with the received identification information.

8. The management apparatus according to claim 7, further comprising:
an input unit that inputs image data to be printed on labels and information to be written into wireless IC elements embedded in the labels; and
a generating unit that generates identification information to identify a set of image data and information to be written for the labels present on one paper sheet among a whole set of a plurality pieces of image data and information to be written, entered by the input unit.

9. An image forming apparatus comprising:
an accepting unit that accepts a paper sheet having a plurality of labels;
a receiving unit that receives image data and identification information to be printed on the paper sheet; and
a printing unit that prints the image data and identification information received by the receiving unit on the paper sheet accepted by the accepting unit.

10. A label creation system comprising:
a management apparatus including a storage unit that stores information to be written into a plurality of wireless IC elements, each including a wireless communication unit and a storage unit storing data that is transmitted and received via the wireless communication unit, and a plurality of pieces of image data to be printed on a plurality of labels present on a paper sheet, associated with identification information; a transmitting unit for information to be printed that transmits, to an image forming apparatus, a set of a plurality of pieces of image data for one paper sheet together with the paper's identification information stored in the storage unit; and a transmitting unit for information to be written that transmits, upon receiving the identification information, a set of a plurality of pieces of information to be written associated with the received identification information;
an image forming apparatus including an accepting unit that accepts a paper sheet embedded with a plurality of wireless IC elements; a receiving unit that receives image data and identification information to be printed on the paper sheet from the management apparatus; and a printing unit that prints the image data and identification information received by the receiving unit on the paper sheet accepted by the accepting unit; and
a writing apparatus including a reading unit that reads identification information from a paper sheet having image data and identification information printed thereon by the image forming apparatus; an acquisition unit that acquires, from the management apparatus, a plurality of pieces of information to be written into the plurality of wireless IC elements, based on the identification information read by the reading unit; and a plurality of writing components that are provided corresponding to the plurality of wireless IC elements and write a plurality of pieces of information to be written acquired by the acquisition unit into the plurality of wireless IC elements, respectively.

11. A computer readable medium storing a program including instructions causing a computer to perform a process comprising:
reading, from a paper sheet having a plurality of labels embedded with wireless IC elements, each including a wireless communication unit and a storage unit storing data that is transmitted and received via the wireless communication unit, identification information to identify a set of pieces of information to be written respectively into the plurality of wireless IC elements;
acquiring a set of a plurality of pieces of information to be written into the plurality of wireless IC elements, based on the identification information which has been read; and
writing the plurality of pieces of information to be written, which have been acquired, into the plurality of wireless IC elements, respectively.
